(19) United States
(12) Patent Application Publication
(10) Pub. No.: US 2019/0276031 A1
(43) Pub. Date: Sep. 12, 2019

(54) VEHICLE MANAGEMENT SYSTEM, VEHICLE MANAGEMENT METHOD, AND STORAGE MEDIUM

(71) Applicant: HONDA MOTOR CO., LTD., Tokyo (JP)

(72) Inventors: Takafumi Hirose, Wako-shi (JP); Naoto Yasuda, Wako-shi (JP); Yuki Oshitani, Tokyo (JP); Susumu Iwamoto, Tokyo (JP)

(21) Appl. No.: 16/288,187

(22) Filed: Feb. 28, 2019

(30) Foreign Application Priority Data
Mar. 6, 2018 (JP) 2018-039731

(51) Int. Cl. B60W 40/08; G06K 9/00; E05B 77/28

(52) U.S. Cl. CPC B60W 40/08; B60W 2040/0809; E05B 77/28; G06K 9/00832

(57) ABSTRACT

Provided a vehicle management system including an information acquirer (182) that acquires information indicating a mode of use of a vehicle on the basis of information acquired by a vehicle device mounted in the vehicle or information received from an external device, a determiner (183) that determines whether an occupant of the vehicle is a restricted person who is subject to restriction of use of an object within the vehicle in accordance with the mode of use of the vehicle acquired by the information acquirer, and a restricting processor (184) that executes a restricting process related to use of the object in a case where the occupant is determined to be the restricted person by the determiner.

### CROSS-REFERENCE TO RELATED APPLICATION

Priority is claimed on Japanese Patent Application No. 2018-039731, filed Mar. 6, 2018, the content of which is incorporated herein by reference.

### BACKGROUND OF THE INVENTION

### Field of the Invention

The present invention relates to a vehicle management system, a vehicle management method, and a storage medium.

### Description of Related Art

Hitherto, the door of a glove box being provided with a locking device in order to enhance the security of a glove box installed in the dashboard of a vehicle has become known. In this connection, automatically unlocking and locking the locking device in accordance with whether an occupant is an authorized occupant in order to reduce the occupant's work of locking or unlocking is known (see, for example, Japanese Unexamined Patent Application, First Publication No. 10-292696).

### SUMMARY OF THE INVENTION

However, in systems of the related art, a mode of use in which only third parties board a vehicle has not been taken into account, and sufficient examination for securing in-vehicle security has not been made in some cases.

The present invention was contrived in view of such circumstances, and one object thereof is to provide a vehicle management system, a vehicle management method, and a storage medium which make it possible to improve in-vehicle security.

A vehicle management system, a vehicle management method, and a storage medium according to this invention have the following configurations adopted therein.

(1) According to an aspect of this invention, there is provided a vehicle management system including: an information acquirer that acquires information indicating a mode of use of a vehicle on the basis of information acquired by a vehicle device mounted in the vehicle or information received from an external device; a determiner that determines whether an occupant of the vehicle is a restricted person who is subject to restriction of use of an object within the vehicle in accordance with the mode of use of the vehicle acquired by the information acquirer; and a restricting processor that executes a restricting process related to use of the object in a case where the occupant is determined to be the restricted person by the determiner.

(2) In the aspect of the above (1), the restricting processor acquires status information indicating a status inside the vehicle on the basis of a detection result of a detector included in an in-vehicle facility or an image captured by an in-vehicle camera mounted within the vehicle, detects an article left within the vehicle as the object on the basis of the acquired status information, and executes the restricting process on the basis of a detection result.

(3) In the aspect of the above (2), the restricting processor executes the restricting process in a case where an action of the occupant relevant to the object is monitored on the basis of the status information and a predetermined action of the occupant is detected.

(4) In the aspect of the above (3), the predetermined action includes an action attempted to touch the object or a stored body stored in the object.

(5) In the aspect of the above (1), the information acquirer acquires information indicating a feature of the occupant on the basis of the information acquired by the vehicle device or the information received from the external device, and the restricting processor decides the object on the basis of at least one of the feature of the occupant acquired by the information acquirer or the mode of use of the vehicle.

(6) In the aspect of the above (1), the restricting process includes any of a process of notifying that the use of the object is restricted and a process of physically or electrically restricting at least a portion of a function of the object.

(7) In the aspect of the above (1), in a case where restriction based on the restricting process is executed by the occupant, the restricting processor notifies an owner of the vehicle to that effect.

(8) In the aspect of the above (1), in a case where restriction based on the restricting process is executed by the occupant, the restricting processor restricts unlocking of a door of the vehicle.

(9) In the aspect of the above (1), in a case where restriction based on the restricting process is executed by the occupant, the restricting processor executes a process for causing the vehicle to travel toward a predetermined place.

(10) In the aspect of the above (2), the restricting processor detects the object using reference information, and a learner that compares a status before the occupant's boarding of the vehicle with a status after the occupant's alighting from the vehicle on the basis of status information indicating a status inside the vehicle which is acquired by the information acquirer, and learns the reference information on the basis of a comparison result is further included.

(11) In the aspect of the above (5), in a case where the mode of use of the vehicle is not set, the determiner determines whether the occupant is the restricted person on the basis of the feature of the occupant.

(12) In the aspect of the above (5), the determiner determines whether the occupant is a conditionally restricted person who is subject to partial restriction of use of the object on the basis of the feature of the occupant.

(13) According to an aspect of this invention, there is provided a vehicle management method including causing one or more computers to: acquire information indicating a mode of use of a vehicle on the basis of information acquired by a vehicle device mounted in the vehicle or information received from an external device; determine whether an occupant of the vehicle is a restricted person who is subject to restriction of use of an object within the vehicle in accordance with the mode of use of the vehicle acquired; and execute a restricting process related to use of the object in a case where the occupant is determined to be the restricted person.

(14) According to an aspect of this invention, there is provided a computer readable non-transitory storage medium having a program stored therein, the program causing one or more computers to: acquire information indicating a mode of use of a vehicle on the basis of information acquired by a vehicle device mounted in the vehicle or information received from an external device; determine whether an occupant of the vehicle is a restricted person who is subject to restriction of use of an object within the vehicle in accordance with the mode of use of the vehicle acquired; and execute a restricting process related to use of the object in a case where the occupant is determined to be the restricted person.

According to the aspects of the above (1) to (14), it is possible to improve in-vehicle security.

### BRIEF DESCRIPTION OF THE DRAWINGS

FIG. 1 is a configuration diagram of a vehicle management system in which a vehicle control device according to a first embodiment is used.

FIG. 2 is a configuration diagram of the vehicle control device according to the first embodiment.

FIG. 3 is a functional configuration diagram of a first controller, a second controller, and a third controller.

FIG. 4 is a diagram illustrating an example of content of restricted person information.

FIG. 5 is a diagram illustrating an example of content of conditional restricted person information.

FIG. 6 is a flowchart illustrating an example of a flow of a process (until a restricting process is executed) performed by the third controller.

FIG. 7 is a flowchart illustrating an example of a flow after the process shown in FIG. 6.

FIG. 8 is a configuration diagram of a management device according to a second embodiment.

FIG. 9 is a diagram illustrating an example of a hardware configuration of an automatic driving control device of an embodiment.

### DETAILED DESCRIPTION OF THE INVENTION

### First Embodiment

Hereinafter, an embodiment of a vehicle management system, a vehicle management method, and a storage device of the present invention will be described with reference to the accompanying drawings. In the following, a case where rules of left-hand traffic is applied will be described, but in a case where rules of right-hand traffic is applied, the right and left may be read reversely.

### [Overall Configuration]

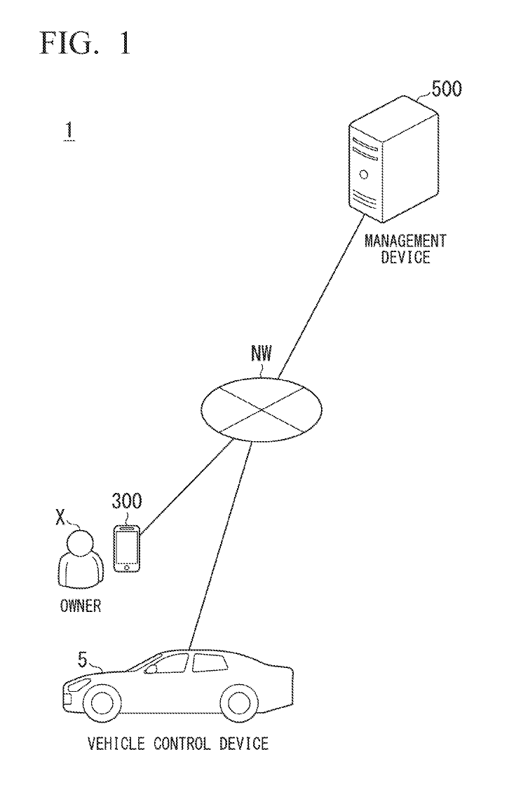

FIG. 1 is a configuration diagram of a vehicle management system 1 according to a first embodiment. The vehicle management system 1 is realized by one or more processors (computers). The vehicle management system 1 includes, for example, one or more vehicle control devices 5, one or more terminal devices 300, and a management device 500. The vehicle control device 5 is an in-vehicle device mounted in an automatically driven vehicle having an automatic driving function. The automatically driven vehicle is, for example, a private car of an owner X. That is, the owner X is an owner of the automatically driven vehicle. The terminal device 300 is a terminal device possessed by the owner X, and is a portable terminal device, such as, for example, a cellular phone such as a smartphone, a tablet terminal, a notebook computer, or a personal digital assistant (PDA), having at least a communication function and an information input and output function. The management device 500 communicates with the vehicle control device 5 or the terminal device 300, and provides various types of information.

The vehicle control device 5, the terminal device 300, and the management device 500 are connected to each other through a network NW, and communicate with each other through this network NW. The network NW includes one or all of, for example, a wide area network (WAN), a local area network (LAN), the Internet, a dedicated channel, a wireless base station, a provider, and the like.

Here, an example of an application scenario of an automatically driven vehicle will be described. For example, it is assumed that the owner X uses an automatically driven vehicle mainly in the daytime during holidays, but hardly uses the automatically driven vehicle on weekdays or during the night in holidays. The vehicle management system 1 can utilize such an automatically driven vehicle of the owner X as a shared car or a taxi in a period in which the owner X does not use the vehicle. For example, in a case where an automatically driven vehicle which is a private car is used as a shared car or a taxi, the vehicle management system 1 executes a process for restricting (hereinafter, referred to as a restricting process) a third party's use of personal possessions, in-vehicle facilities or the like of the owner X. The vehicle management system 1 may execute the restricting process in a case where, for example, a child or an older person rather than a third party boards the vehicle. The application scenario is not limited to the above, and the automatically driven vehicle may be utilized as a shared car or a taxi, for example, during a period in which the owner X departs from his or her home on board the automatically driven vehicle and is staying at a shopping mall which is a destination. The automatically driven vehicle may be utilized as a courtesy car that travels with the owner's children or grandparents only taken on board without the owner being on board.

[Vehicle Control Device 5]

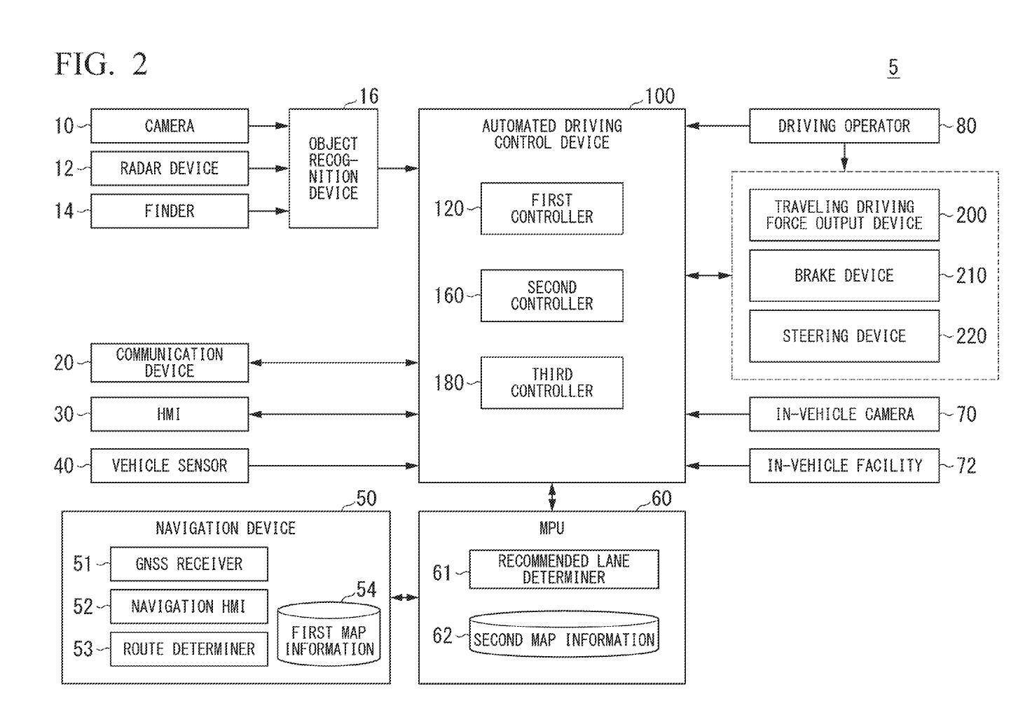

Next, the vehicle control device 5 will be described. FIG. 2 is a configuration diagram of the vehicle control device 5 according to the first embodiment. A vehicle having the vehicle control device 5 mounted therein is, for example, a two-wheeled, three-wheeled, or four-wheeled vehicle or the like, and the driving source thereof is an internal-combustion engine such as a diesel engine or a gasoline engine, an electric motor, or a combination thereof. The electric motor operates using power generated by a generator connected to an internal-combustion engine or discharging power of a secondary battery or a fuel cell.

The vehicle control device 5 includes, for example, a camera 10, a radar device 12, a finder 14, an object recognition device 16, a communication device 20, a human machine interface (HMI) 30, a vehicle sensor 40, a navigation device 50, a map positioning unit (MPU) 60, an in-vehicle camera 70, an in-vehicle facility 72, a driving operator 80, an automatic driving control device 100, a traveling driving force output device 200, a brake device 210, and a steering device 220.

These devices or instruments are connected to each other through a multiplex communication line such as a controller area network (CAN) communication line, a serial communication line, a wireless communication network, or the like. The configuration shown in FIG. 2 is merely an example, and portions of the configuration may be omitted, or other constituents may be added thereto. The camera 10 is a digital camera using a solid-state imaging element such as, for example, a charge coupled device (CCD) or a complementary metal oxide semiconductor (CMOS). The camera 10 is installed at any points on an automatically driven vehicle having the vehicle control device 5 mounted therein. In a case where a forward image is captured, the camera 10 is installed on the upper portion of the front windshield, the rear surface of the rear-view mirror, or the like. The camera 10, for example, repeatedly captures an image of the vicinity of an automatically driven vehicle periodically. The camera 10 may be a stereo camera.

The radar device 12 radiates radio waves such as millimeter-waves to the vicinity of an automatically driven vehicle, and detects radio waves (reflected waves) reflected from an object to detect at least the position (distance to and orientation) of the object. The radar device 12 is installed at any points on the automatically driven vehicle. The radar device 12 may detect the position and speed of an object using a frequency modulated continuous wave (FM-CW) system.

The finder 14 is a light detection and ranging (LIDAR) finder. The finder 14 irradiates the vicinity of the automatically driven vehicle with light, and measures scattered light. The finder 14 detects a distance to an object on the basis of a time from light emission to light reception. The irradiation light is, for example, pulsed laser light. The finder 14 is installed at any points on the automatically driven vehicle.

The object recognition device 16 recognizes the position, type, speed, or the like of an object by performing a sensor fusion process on detection results based on some or all of the camera 10, the radar device 12, and the finder 14. The object recognition device 16 outputs the recognition results to the automatic driving control device 100. The object recognition device 16 may output the detection results of the camera 10, the radar device 12, and the finder 14, as they are, to the automatic driving control device 100. The vehicle control device 5 to the object recognition device 16 may be omitted.

The communication device 20 communicates another vehicle which is present in the vicinity of the automatically driven vehicle using, for example, a cellular network, a Wi-Fi network, Bluetooth (registered trademark), dedicated short range communication (DSRC), or the like, or communicates with server devices of various types through a wireless base station.

The HMI 30 provides various types of information for an occupant of the automatically driven vehicle, and accepts the occupant's input operation. The HMI 30 includes various types of display devices, a speaker, a buzzer, a touch panel, a switch, a key, and the like.

The vehicle sensor 40 includes a vehicle speed sensor that detects the speed of an automatically driven vehicle, an acceleration sensor that detects an acceleration, a yaw rate sensor that detects an angular velocity around a vertical axis, an orientation sensor that detects the direction of an automatically driven vehicle, or the like.

The navigation device 50 includes, for example, a global navigation satellite system (GNSS) receiver 51, a navigation HMI 52, and a route determiner 53. The navigation device 50 holds first map information 54 in a storage device such as a hard disk drive (HDD) or a flash memory. The GNSS receiver 51 specifies the position of the automatically driven vehicle on the basis of a signal received from a GNSS satellite. The position of the automatically driven vehicle may be specified or complemented by an inertial navigation system (INS) in which an output of the vehicle sensor 40 is used. The navigation HMI 52 includes a display device, a speaker, a touch panel, a key, and the like. The navigation HMI 52 may be made to be the same with respect to a portion or the entirety of the above-described HMI 30. The route determiner 53 decides, for example, a route (hereinafter, a route on a map) from the position (or any input position) of the automatically driven vehicle specified by the GNSS receiver 51 to a destination input by an occupant using the navigation HMI 52 with reference to the first map information 54. The first map information 54 is, for example, information in which a road shape is represented by a link indicating a road and nodes connected by the link. The first map information 54 may include the curvature of a road, point of interest (POI) information, or the like. The route on a map is output to the MPU 60. The navigation device 50 may perform route guidance using the navigation HMI 52 on the basis of the route on a map. The navigation device 50 may be realized by the function of a terminal device such as, for example, a smartphone or a tablet terminal possessed by an occupant. The navigation device 50 may transmit its current position and destination to a navigation server through the communication device 20, and acquire the same route as the route on a map from the navigation server.

The MPU 60 includes, for example, a recommended lane determiner 61, and holds second map information 62 in a storage device such as an HDD or a flash memory. The recommended lane determiner 61 divides the route on a map provided from the navigation device 50 into a plurality of blocks (for example, divides the route on a map every 100 [m] in a vehicle traveling direction), and decides a recommended lane for each block with reference to the second map information 62. The recommended lane determiner 61 makes a decision on which lane from the left to travel along.

In a case where a branch point is present in the route on a map, the recommended lane determiner 61 decides a recommended lane so that the automatically driven vehicle can travel along a rational route for advancing to a branch destination.

The second map information 62 is map information having a higher accuracy than that of the first map information 54. The second map information 62 includes, for example, information of the center of a lane, information of the boundary of a lane, or the like. The second map information 62 may include road information, traffic regulations information, address information (address or zip code), facility information, telephone number information, or the like. The second map information 62 may be updated at any time by the communication device 20 communicating with another device.

The in-vehicle camera 70 is a digital camera using a solid-state image sensing device such as, for example, a CCD or a CMOS. The in-vehicle camera 70 is installed at any points for capturing an image of the interior of the automatically driven vehicle.

The in-vehicle facility 72 is a facility mounted in the automatically driven vehicle, and includes, for example, a cup holder, an article rack box, a storage box provided in a dashboard, a magazine rack box, a DVD reproduction device, a CD reproduction device, other information processing devices, a safety device, a billing process device, a settlement process device, and the like. The in-vehicle facility 72 acquires information indicating a status of use, and output the acquired information to the automatic driving control device 100. For example, the in-vehicle facility 72 may include a detector or the like that detects articles received in a receiving space, and acquires information indicating a status of use on the basis of detection results based on the detector. The in-vehicle facility 72 may include a display device such as a light emitting diode (LED).

The driving operator 80 includes, for example, an accelerator pedal, a brake pedal, a shift lever, a steering wheel, a variant steering wheel, a joystick, and other operators. A sensor that detects the amount of operation or the presence or absence of operation is installed on the driving operator 80, and the detection results are output to the automatic driving control device 100, or some or all of the traveling driving force output device 200, the brake device 210, and the steering device 220.

The automatic driving control device 100 includes, for example, a first controller 120 and a second controller 160. The first controller 120 and the second controller 160 are realized by a hardware processor such as, for example, a central processor (CPU) executing a program (software). Some or all of these components may be realized by hardware (circuit unit; including circuitry) such as a large scale integration (LSI), an application specific integrated circuit (ASIC), a field-programmable gate array (FPGA), or a graphics processor (GPU), and may be realized by cooperation between software and hardware. The program may be stored in a storage device such as the HDD or the flash memory of the automatic driving control device 100 in advance, may be stored in a detachable storage medium such as a DVD or a CD-ROM, or may be installed in the HDD or the flash memory of the automatic driving control device 100 by the storage medium being mounted in a drive device.

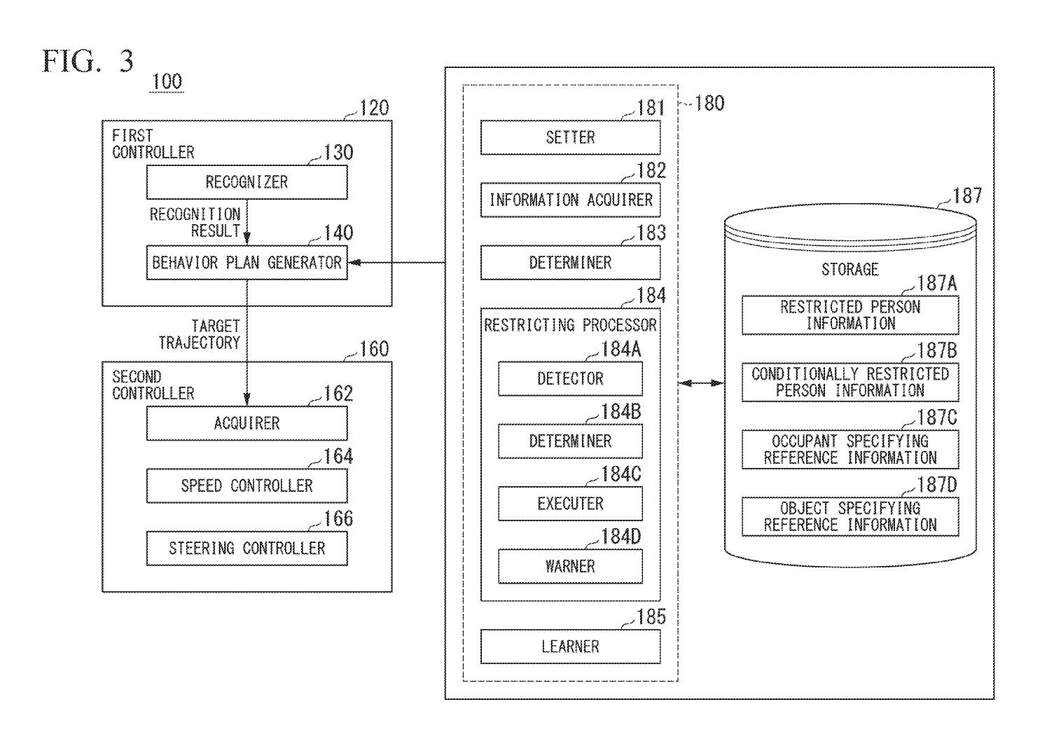

FIG. 3 is a functional configuration diagram of the first controller 120, the second controller 160, and a third controller 180. The first controller 120 includes, for example, a recognizer 130 and a behavior plan generator 140. The first controller 120 or the third controller 180 concurrently realize, for example, a function based on artificial intelligence (AI) and a function based on a model imparted in advance. For example, a function of “recognizing a point of intersection” may be realized by the recognition of a point of intersection based on deep leaning or the like and recognition based on conditions (such as a signal capable of pattern matching for a road sign) imparted in advance being concurrently executed, and being comprehensively evaluated by performing scoring on both. Thereby, the reliability of automatic driving is secured.

The recognizer 130 recognizes the position and speed of an object which is present in the vicinity of the automatically driven vehicle, and the state of an acceleration or the like on the basis of information which is input from the camera 10, the radar device 12, and the finder 14 through the object recognition device 16. The position of the object is recognized as, for example, a position in absolute coordinates with a representative point (such as the centroid or the center of a drive shaft) of the automatically driven vehicle as an origin, and is used in control. The position of the object may be represented by a representative point such as the centroid or a corner of the object, or may be represented by a representative region. The “state” of the object may include the acceleration or jerk of the object, or “behavior state” (for example, whether performing or attempt to perform lane change).

The recognizer 130 recognizes, for example, a lane (traveling lane) along which the automatically driven vehicle travels. For example, the recognizer 130 may recognize a traveling lane by comparing a pattern of a road division line (for example, an array of solid lines and broken lines) obtained from the second map information 62 with a pattern of a road division line located in the vicinity of the automatically driven vehicle which is recognized from an image captured by the camera 10. The recognizer 130 may recognize a traveling lane by recognizing a driving boundary (road boundary) including a road division line, a shoulder, a curbstone, a median strip, a guardrail, or the like without being limited to the recognition of a road division line. In this recognition, the position of the automatically driven vehicle acquired from the navigation device 50 or processing results based on an INS may be added. The recognizer 130 recognizes a stop line, an obstacle, a red light, a tollbooth, and other road events.

On recognizing a traveling lane, the recognizer 130 recognizes the position or posture of the automatically driven vehicle with respect to the traveling lane. The recognizer 130 may recognize, for example, deviation from the center of the lane of the automatically driven vehicle which is a reference point, and an angle formed with respect to a line aligned along the center of the lane of the automatically driven vehicle in its traveling direction, as the relative position and posture of the automatically driven vehicle with respect to the traveling lane. Instead thereof, the recognizer 130 may recognize the position of the reference point of the automatically driven vehicle or the like with respect to either lateral end portion (a road division line or a road boundary) of the traveling lane, as the relative position of the automatically driven vehicle with respect to the traveling lane.

The behavior plan generator 140 generates a target trajectory along which the automatically driven vehicle will travel in the future automatically (irrespective of a driver's operation) so that the automatically driven vehicle travels along the recommended lane decided by the recommended lane determiner 61 in principle and can cope with its peripheral situation. The target trajectory includes, for example, a speed element. For example, the target trajectory may be represented as a trajectory obtained by arranging points (trajectory points) at which the automatically driven vehicle will arrive in order. The trajectory points are points at which the automatically driven vehicle will arrive after predetermined traveling distances (for example, approximately every several [m]) which is a distance along a road. Separately from the trajectory points, a target speed and a target acceleration for each predetermined sampling time (for example, approximately every several tenths of a [sec]) are generated as a portion of the target trajectory. The trajectory points may be positions at which the automatically driven vehicle will arrive at sampling times for respective predetermined sampling times. In this case, information of a target speed or a target acceleration is represented by an interval between trajectory points.

The behavior plan generator 140 may set automatic driving events when generating a target trajectory. Examples of automatic driving events include a constant-speed traveling event, a low-speed following traveling event, a lane change event, a diverging event, a merging event, an overtaking event, and the like. The behavior plan generator 140 generates a target trajectory according to a started event.

The second controller 160 controls the traveling driving force output device 200, the brake device 210, and the steering device 220 so that the automatically driven vehicle passes along the target trajectory generated by the behavior plan generator 140 according to scheduled times.

The second controller 160 includes, for example, an acquirer 162, a speed controller 164, and a steering controller 166. The acquirer 162 acquires information of the target trajectory (trajectory point) generated by the behavior plan generator 140, and stores the acquired information in a memory (not shown). The speed controller 164 controls the traveling driving force output device 200 or the brake device 210 on the basis of a speed element associated with the target trajectory stored in the memory. The steering controller 166 controls the steering device 220 in accordance with the bent state of the target trajectory stored in the memory. The processes of the speed controller 164 and the steering controller 166 are realized by, for example, a combination of feedforward control and feedback control. As an example, the steering controller 166 executes a combination of feedforward control according to the curvature of a road in front of the automatically driven vehicle and feedback control based on deviation from the target trajectory.

The traveling driving force output device 200 outputs a traveling driving force (torque) for a vehicle to travel to a driving wheel. The traveling driving force output device 200 includes, for example, a combination of an internal-combustion engine, an electric motor, a transmission or the like, and an ECU that controls these components. The ECU controls the above components in accordance with information which is input from the second controller 160 or information which is input from the driving operator 80.

The brake device 210 includes, for example, a brake caliper, a cylinder that transfers hydraulic pressure to the brake caliper, an electric motor that generates hydraulic pressure in the cylinder, and a brake ECU. The brake ECU controls the electric motor in accordance with the information which is input from the second controller 160 or the information which is input from the driving operator 80, and causes a brake torque according to a braking operation to be output to each wheel. The brake device 210 may include a mechanism, which transfers hydraulic pressure generated by the operation of a brake pedal included in the driving operator 80 through a master cylinder to the cylinder, as a backup. The brake device 210 is not limited to the above-described configuration, and may be an electronic control type hydraulic brake device that controls an actuator in accordance with the information which is input from the second controller 160 and transfers hydraulic pressure of the master cylinder to the cylinder.

The steering device 220 includes, for example, a steering ECU and an electric motor.

The electric motor changes the direction of a turning wheel, for example, by causing a force to act on a rack and pinion mechanism. The steering ECU drives the electric motor in accordance with the information which is input from the second controller 160 or the information which is input from the driving operator 80, and changes the direction of the turning wheel.

The third controller 180 includes, for example, a setter 181, an information acquirer 182, a determiner 183, a restricting processor 184, a learner 185, and a storage 187.

The storage 187 is, for example, a random access memory (RAM), a read only memory (ROM), a flash memory such as a solid state drive (SSD), a hard disk drive (HDD), or the like. The storage 187 stores information such as, for example, restricted person information 187A, conditionally restricted person information 187B, occupant specifying reference information 187C, or object specifying reference information 187D.

The restricted person information 187A is information relating to a restricted person. The term “restricted person” refers to a person who is subject to restriction of use of an object within the automatically driven vehicle. The object includes, for example, at least one of the communication device 20, a portion of the HMI 30, a portion of the in-vehicle facility 72, or a portion of personal possessions left within the automatically driven vehicle. The object may be the object itself, or may be a portion of a function of the object. The wording “left within the automatically driven vehicle” refers to a state of being introduced from outside of the automatically driven vehicle and then not moving out of the outside, and means that an object such as the in-vehicle facility 72 which is installed in the automatically driven vehicle is excluded. The personal possession may be an object, or may be information stored in the storage. Examples of the personal possession include an occupant's lost belonging, in-vehicle equipment, and the like. Examples of the in-vehicle equipment include a tissue, a paper cup, a dustcloth, a cushion, a magazine, and the like which are installed within the automatically driven vehicle. The in-vehicle equipment may include things which are provided from the owner X to a customer of a shared car or the like, and the in-vehicle equipment placed for such a purpose may be excluded from the object.

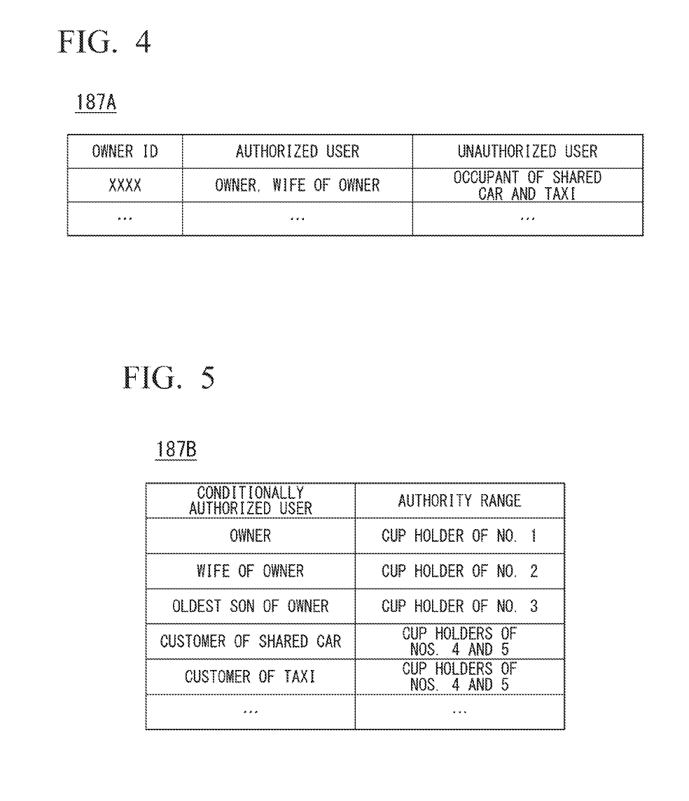

FIG. 4 is a diagram illustrating an example of content of the restricted person information 187A. As shown in FIG. 4, the restricted person information 187A is information in which an authorized user and an unauthorized user are associated with an owner ID. The owner ID is information for identifying each owner. The term “authorized user” refers to a user with authority to use personal possessions or a portion of the in-vehicle facility 72. The term “unauthorized user” refers to a user without authority to use personal possessions or a portion of the in-vehicle facility 72. That is, the unauthorized user is an example of the restricted person.

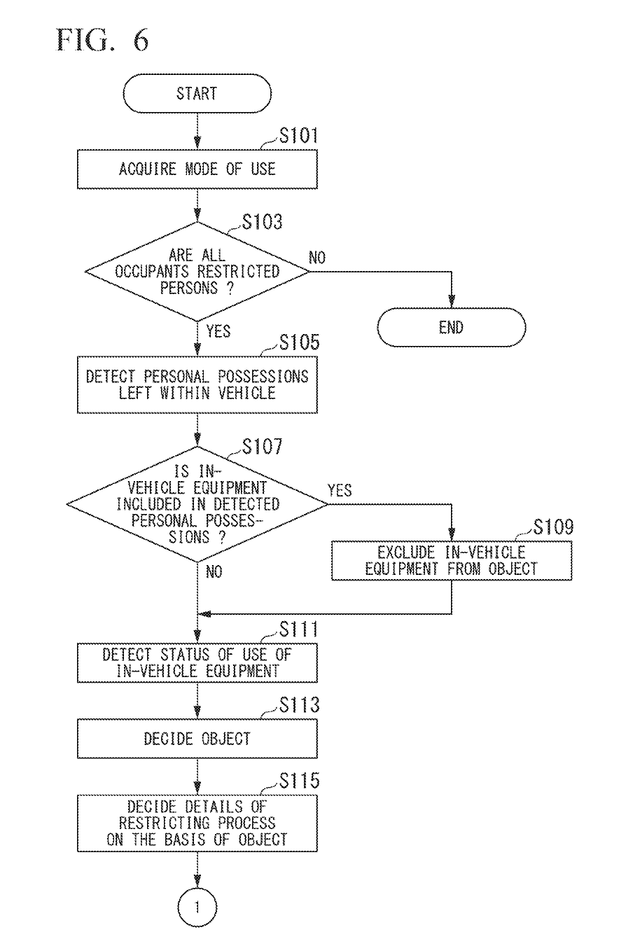

The conditionally restricted person information 187B is information relating to a conditionally restricted person or the person's authority range. The term “conditionally restricted person” refers to a person to whom a restricted range smaller than the restricted range of a restricted person is assigned. FIG. 5 is a diagram illustrating an example of content of the conditionally restricted person information 187B. As shown in FIG. 5, the conditionally restricted person information 187B is information in which an authority range is associated with a conditionally authorized user. The conditionally authorized user is information indicating a user to which a conditional authority is given. The authority range may be information indicating a permitted authority range, or may be information indicating a restricted authority. The authority range may be set for each object (such as a personal possession or the in-vehicle facility 72).

The occupant specifying reference information 187C is information referred to in order to specify an occupant. For example, the occupant specifying reference information 187C includes information (an image feature amount indicating a user's face) for specifying an authorized user through face authentication, individual specifying information of an authorized user, or the like. The individual specifying information may include, for example, a name, a nickname, an ID or the like of a user. The occupant specifying reference information 187C may include information referred to in order to specify an unauthorized user.

The object specifying reference information 187D information referred to in order to specify an object. For example, the object specifying reference information 187D includes information (for example, an image feature amount of an object) for specifying an object through image processing, possession specifying information indicating a feature of an object, or the like. The possession specifying information includes, for example, the type, color, size, shape, material, mark (such as a logo), or the like of a possession. The object specifying reference information 187D may include information referred to in order to specify a thing (such as, for example, the in-vehicle equipment) which is not an object.

The setter 181 updates the information stored in the storage 187 on the basis of, for example, information received from the terminal device 300 using the communication device 20. The setter 181 may update each piece of information on the basis of operation information which is input through the HMI 30.

The information acquirer 182 acquires information indicating the mode of use of a vehicle on the basis of information acquired by a vehicle device mounted in the vehicle or information received from an external device. For example, the information acquirer 182 acquires information indicating the mode of use of the automatically driven vehicle on the basis of information set by the owner X using the HMI 30, and outputs the acquired information to the determiner 183. The HMI 30 is an example of the vehicle device mounted in a vehicle. For example, the information acquirer 182 may receive information set by the owner X using the terminal device 300 from the terminal device 300 or the management device 500, and acquire information indicating the mode of use of the automatically driven vehicle on the basis of the received information. The terminal device 300 or the management device 500 is an example of the external device.

The mode of use of the automatically driven vehicle includes a mode of use by a person affiliated with an owner and a mode of use by a third party. In the mode of use by a person affiliated with an owner is, for example, at least one person out of occupants is a person (registered in advance) who is affiliated with an owner, and persons other than a person affiliated with an owner may be on board the vehicle. The mode of use by a third party includes, for example, a case in which the automatically driven vehicle travels as a shared car or a taxi. The mode of use by a third party also includes a case in which the automatically driven vehicle alone is directed to a cleaning facility in an unmanned state according to an instruction of the owner X, arrives at the cleaning facility, and then is cleaned by a third party.

In a case where the mode of use of the automatically driven vehicle is installed by the management device 500, the information acquirer 182 may acquire information indicating the mode of use of the automatically driven vehicle from the management device 500. The information acquirer 182 may determine the mode of use of the automatically driven vehicle on the basis of image data (or moving image data, the same applies hereinafter) captured by the in-vehicle camera 70. The in-vehicle camera 70 is an example of the vehicle device mounted in a vehicle. For example, the information acquirer 182 refers to the occupant specifying reference information 187C using a face authentication technique by analyzing the image data captured by the in-vehicle camera 70, and specifies an occupant through comparison with the image feature amount of a user's face registered beforehand. In a case where a user registered beforehand is included among occupants, the information acquirer 182 may determine that the mode of use of the automatically driven vehicle is the mode of use by a person affiliated with an owner.

The information acquirer 182 may refer to the information stored in the storage 187 on the basis of, for example, operation information which is input through the HMI 30 or output information from the in-vehicle camera 70, determine the feature of an occupant, and create information indicating the feature of an occupant on the basis of the determination result. The feature of an occupant includes, for example, a status according to the mode of use of the automatically driven vehicle, attributes (age or sex) of occupants who board the automatically driven vehicle, the number of occupants, individual specifying information (name, nickname, or ID) of occupants, or the like. The information acquirer 182 may determine the feature of an occupant on the basis of the mode of use of the automatically driven vehicle, and create information indicating the feature of an occupant on the basis of the determination result.

The determiner 183 determines whether the occupant is a restricted person in accordance with the mode of use of the automatically driven vehicle. For example, in a case where the mode of use of the automatically driven vehicle is use by the owner X, the determiner 183 determines that the occupant is not a restricted person. In a case where the mode of use of the automatically driven vehicle is a shared car or a taxi, the determiner 183 determines that the occupant is a restricted person.

The determiner 183 may refer to various types of information stored in the storage 187, and determine whether the occupant is a restricted person on the basis of information (information indicating the feature of the occupant of the automatically driven vehicle) acquired by the information acquirer 182. For example, in a case where the mode of use of the automatically driven vehicle is not set, the determiner 183 may determine whether the occupant is a restricted person on the basis of the information indicating the feature of the occupant of the automatically driven vehicle. Specifically, in a case where the feature of the occupant of the automatically driven vehicle acquired by the information acquirer 182 is registered as an “unrestricted user” in the restricted person information 187A, the determiner 183 determines that the occupant is a restricted person. In a case where at least one occupant determined not to be a restricted person is present among a plurality of occupants, the determiner 183 may determine that the occupant is not a restricted person.

For example, in a case where the individual specifying information is included in the information acquired by the information acquirer 182, the determiner 183 may refer to the information stored in the storage 187, and determine whether a user indicated by the individual specifying information is a restricted person. The information acquirer 182 may refer to the information stored in the storage 187, and determine whether a user indicated by personal information is a restricted person on the basis of the personal information of the occupant specified by face authentication performed by the information acquirer 182.

The determiner 183 may refer to the conditionally restricted person information 187B, and determine whether a conditionally restricted person is included in the occupants. For example, in a case where it is determined that the occupant is not a restricted person on the basis of the mode of use of the automatically driven vehicle, the determiner 183 may determine whether a conditionally restricted person is included in the occupants. In a case where the mode of use of the automatically driven vehicle is not set, the determiner 183 may determine whether a conditionally restricted person is included in the occupants. For example, in a case where the mode of use of the automatically driven vehicle is use by the owner X, and a user defined as a “conditionally restricted user” in the conditionally restricted person information 187B is included in the occupants, the determiner 183 determines that a conditionally restricted person is included in the occupants.

In a case where it is determined by the determiner 183 that the occupant is a restricted person (or, includes a conditionally restricted person), the restricting processor 184 executes a restricting process related to use of an object.

The restricting processor 184 includes, for example, a detector 184A, a determiner 184B, and an executer 184C. In the following, a process performed by each configuration unit included in the restricting processor 184 is a portion of a restricting process.

The detector 184A refers to the information stored in the storage 187, and detects a personal possession left within a vehicle on the basis of, for example, the image data captured by the in-vehicle camera 70. The detector 184A may detect a personal possession of the owner X, or may detect a personal possession (such as, for example, a lost belonging of a user who has used a shared car) of an occupant who has previously boards a vehicle. For example, the detector 184A compares an image (hereinafter, referred to as an initial image) obtained by imaging the interior of a vehicle in an initial state (for example, a state when a vehicle has been delivered) with an image (hereinafter, referred to as a last image) captured after it is determined by the determiner 183 that the occupant is a restricted person, and detects an article which is not present in the initial image and appears in the last image as a personal possession. The detector 184A may compare an image (hereinafter, referred to as an image before boarding) obtained by imaging the interior of a vehicle in a state before an occupant boards the vehicle (for example, a state before a customer of a shared car boards the vehicle) with an image (hereinafter, referred to as an image after alighting) obtained by imaging the interior of the vehicle in a state after an occupant alights from the vehicle, and detect an article which is not present in the image before boarding and appears in the image after alighting as a personal possession. Without being limited thereto, the detector 184A may detect an image of a personal possession from the last image on the basis of feature information registered in advance. The detector 184A may detect the rest except the in-vehicle equipment from candidates of the detected personal possessions as a personal possession.

The detector 184A detects the status of use of the in-vehicle facility 72 on the basis of an output from the in-vehicle facility 72. For example, in a case where information indicating that a DVD is contained in a DVD reproduction device included in the in-vehicle facility 72 is input, the detector 184A detects a status of use in which the DVD is contained (is being used). In a case where information indicating that something is contained in a cup holder included in the in-vehicle facility 72 is input, the detector 184A detects a status of use in which the cup holder is being used. In a case where information indicating that an automatic brake function is set to on from a safety device included in the in-vehicle facility 72 is input, the detector 184A may detect a status of use in which the automatic brake function of the safety device is being used.

The determiner 184B decides an object which is a target of a restricting process on the basis of the detection result based on the detector 184A. For example, the determiner 184B decides the personal possession detected by the detector 184A or the in-vehicle facility 72 for which it is detected that the status of use detected by the detector 184A is being used, as the object.

The determiner 184B may decide an object on the basis of the feature of the occupant acquired by the information acquirer 182. For example, the determiner 184B may exclude an article, according to the feature of the occupant among object candidates including the personal possession detected by the detector 184A, the in-vehicle facility 72 for which it is detected that the status of use detected by the detector 184A is being used, or the like, from the object. For example, the determiner 184B refers to the conditionally restricted person information 187B on the basis of the information indicating the feature of the occupant acquired by the information acquirer 182, and determines whether a personal possession or the in-vehicle facility 72 (hereinafter, referred to as an authority given article) for which authority is given only a specific occupant is present among the object candidates. For example, in a case where a cup holder used in accordance with the feature of the occupant is set, the determiner 184B determines that the authority given article is present among the object candidates, and decides the rest except the authority given article from the object candidates as the object.

The determiner 184B may decide an object in accordance with the mode of use of the automatically driven vehicle. For example, in a case where the mode of use of the automatically driven vehicle is a taxi, the determiner 184B excludes a billing meter included in the in-vehicle facility 72 from the object. In a case where the mode of use of the automatically driven vehicle is a shared car, the determiner 184B causes the billing meter included in the in-vehicle facility 72 to be included in the object. The determiner 184B may decide the in-vehicle facility 72 or the like for which it is detected that the status of use detected by the detector 184A is not being used in accordance with the mode of use of the automatically driven vehicle, as the object. For example, in a case where the mode of use is use by a third party, the billing processing device or the settlement process device included in the in-vehicle facility 72, the communication device 20, and a portion of a function of the HMI 30 may be decided as the object in accordance with the content of the mode of use.

The executer 184C decides a restricting process according to the object decided by the determiner 184B, and executes the decided restricting process. The restricting process includes a process for notifying of the fact that use of the object is restricted, a process for physically or electrically restricting at least a portion of a function of the object, or the like. In a case where the number of use patterns with respect to the object is plural, or a case where use patterns with respect to the object can be set in stages, the executer 184C may change the use patterns as the restricting process. For example, in a case where a plurality of use patterns in which a bag placed on a seat is displaced to another seat, put below the feet, moved to a trunk, shifted slightly, prohibited from being touched, or the like are set in accordance with the object, the executer 184C executes the restricting process according to the object. In a case where a threshold according to the degree of use of the object can be set, the executer 184C may change the threshold in accordance with the object, the mode of use of the automatically driven vehicle, the feature of the occupant, or the like. By changing the threshold, the executer 184C can realize the restricting process in which, for example, the reproduction of a DVD device is not restricted, taking out of a disk from the DVD device is restricted, both reproduction and taking out of a disk 1 of the DVD device are restricted, those of disk 2 are not restricted, or the like

The process for notifying of the fact that use of the object is restricted includes display of notification content in the HMI 30, output of notification content from the HMI 30 using a sound, turn-on or blink of an LED provided for the in-vehicle facility 72 in which an object is left, or the like. Turn-on or blink of an LED provided for the in-vehicle facility 72 in which the object is left includes, for example, a process for turning on an LED of the cup holder in which a plastic bottle is left, or the like. The process for notifying of the fact that use of the object is restricted includes, for example, a process for outputting a sound such as “Please do not touch the bag on the seat.” The executer 184C may notify of information indicating a restricted action as the restriction of use of the object. The restricted action includes, for example, at least one of an action of touching an object or a stored body stored in the object, an action attempted to take out a stored body stored in the object, and an action attempted to take away an object or a stored body stored in the object.

The process for physically restricting at least a portion of a function of the object includes, for example, locking of a storage door, covering of a receiving space such as the cup holder with a lid, or the like. The process for electrically restricting at least a portion of a function of the object includes, for example, not turning on of a power supply of the object even when the power supply is indicated to be turned on, or the like. For example, in a case where the object is a receiving box of the dashboard, the executer 184C electrically locks the door of a storage box provided in the dashboard.

In a case where the object is an automatic brake function of the safety device, the executer 184C executes a process in which a setting related to the automatic brake function is not accepted in the HMI 30, a process in which the automatic brake function is not turned on even in a case where indication for turning on the automatic brake function using the HMI 30 is input, or the like.

The executer 184C may decide a restricting process according to the mode of use of the automatically driven vehicle or the feature of the occupant, for each object, on the basis of the information indicating the mode of use of the automatically driven vehicle acquired by the information acquirer 182, the information indicating the feature of the occupant, or the like. For example, in a case where the object is a DVD device included in the in-vehicle facility 72, the executer decides to restrict all the functions of the DVD device when the occupant is a customer of a shared car, and decides to restrict the replacement of a disk without restricting the reproduction of the DVD device when the occupant is an owner's child.

The executer 184C may decide the degree of restriction in the restricting process on the basis of the information indicating the mode of use of the automatically driven vehicle acquired by the information acquirer 182, the information indicating the feature of the occupant, or the like. The degree of restriction in the restricting process includes, for example, strengthening the restriction, slightly strengthening the restriction, slightly weakening the restriction, weakening the restriction, or the like.

In a case where it is determined whether the occupant determined to be a restricted person uses the object, and it is determined that the occupant uses the object, the executer 184C may cause the vehicle control device 5 to execute the restricting process. The status in which the occupant uses the object includes, for example, a status in which the occupant attempts to touch the object, a status in which the occupant attempts to take out a stored body stored in the object, or the like. For example, the executer 184C monitors the occupant's action with respect to the object on the basis of the image data captured by the in-vehicle camera 70. In a case where the occupant's predetermined action with respect to the object is detected, the executer 184C may execute the restricting process. The predetermined action includes an action of reaching for the object, an action attempted to take out a stored body stored in the object, or the like. For example, in a case where it is detected that a customer of a taxi reaches for a personal possession of the owner X, the executer 184C notifies the customer of no touch of the personal possession. Without being limited thereto, the executer 184C may execute the restricting process at a timing when a restricted person boards the automatically driven vehicle or a timing when the automatically driven vehicle starts.

The warner 184D analyzes the in-vehicle status (including a change of the position of the object, an action of the occupant, or the like) of the automatically driven vehicle on the basis of the image data captured by the in-vehicle camera 70. The warner 184D determines whether restriction based on the restricting process executed by the executer 184C is executed by the occupant on the basis of the analysis result. In a case where the degree of restriction of the restricting process executed by the executer 184C is weak, the warner 184D may not determine that restriction based on the restricting process is executed by the occupant even in a case where the restricting process is executed just one time. That is, the number of times of permission is set for each restricting process. In a case where the number of times the occupant executes restriction exceeds the number of times of permission, the warner 184D may not determine that restriction based on the restricting process is executed by the occupant.

In a case where it is determined that restriction based on the restricting process is executed by the occupant, the warner 184D outputs a warning message from the HMI 30. The warning message includes a predetermined warning sound, “Please do not touch there,” “Please do not take this bag away,” or the like.

In a case where it is determined that restriction based on the restricting process is executed by the occupant, the warner 184D transmits a message indicating the effect to the terminal device 300, and notifies the owner X of the message. The warner 184D may generate an evidence image indicating that restriction based on the restricting process is executed by the occupant on the basis of the image data captured by the in-vehicle camera 70, and transmit the generated image to the terminal device 300. In a case where it is determined that restriction based on the restricting process is executed by the occupant, the warner 184D may restrict unlocking of the door of the automatically driven vehicle.

In a case where it is determined that restriction based on the restricting process is executed by the occupant, the warner 184D may execute a process for causing the automatically driven vehicle to travel toward a predetermined destination (for example, a police box). For example, the warner 184D instructs the navigation device 50 to search for a police box closest from a current position, and to decide a route to the police box (destination) obtained by the search. Thereby, the MPU 60 decides a recommended lane, the behavior plan generator 140 decides an event, or the behavior plan generator 140 generates a target trajectory. The second controller 160 controls each device on the basis of information which is output from the first controller 120 through such a process, and thus the automatically driven vehicle can travel to the police box using automatic driving.

The learner 185 learns the occupant specifying reference information 187C or the object specifying reference information 187D on the basis of the image data captured by the in-vehicle camera 70, the operation information which is input through the HMI 30, the information received from the terminal device 300 or the management device 500, or the like. For example, the learner 185 compares an image captured by the in-vehicle camera 70 before the occupant's boarding with an image captured by the in-vehicle camera 70 after the occupant's alighting, and learns the object specifying reference information 187D on the basis of the comparison result.

[Process Flow]

Hereinafter, a flow of each process performed by the third controller 180 of an embodiment will be described with reference to a flow chart. FIG. 6 is a flow chart illustrating an example of a flow of processes (until the restricting process is executed) performed by the third controller 180.

First, the information acquirer 182 acquire, for example, information indicating the mode of use of the automatically driven vehicle (step S101). The determiner 183 determines whether all occupants are restricted persons on the basis of the information acquired by the information acquirer 182 (step S103). In a case where it is determined that at least one person which is not a restricted person is included in the occupants, the third controller 180 terminates the process. On the other hand, in step S103, in a case where it is determined that all the occupants are restricted persons, the detector 184A detects personal possessions left within the vehicle (step S105). The determiner 184B determines whether the in-vehicle equipment is included in the personal possessions detected by the detector 184A (step S107). In a case where the in-vehicle equipment is included in the detected personal possessions, the determiner 184B excludes the in-vehicle equipment from the detected personal possessions, and decides the remaining article as the object (step S109).

Next, the detector 184A detects the status of use of the in-vehicle facility of the automatically driven vehicle (step S111). The determiner 184B decides the in-vehicle facility 72 for which it is detected that the status of use detected by the detector 184A is being used, as the object (step S113). That is, the object includes both the object decided in step S109 and the object decided in step S113. Next, the executer 184C decides a restricting process according to the object determined by the determiner 184B, and executes the decided restricting process (step S115).

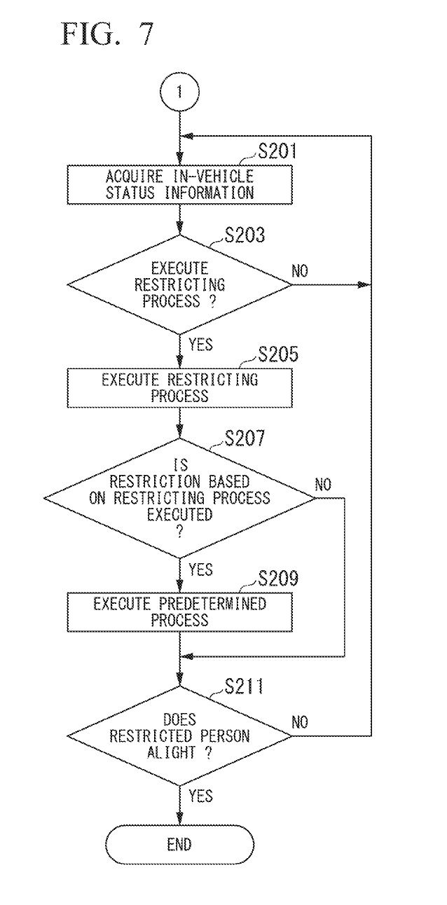

FIG. 7 is a flow chart illustrating an example of a flow after the process shown in FIG. 6. The executer 184C acquires in-vehicle status information (step S201). The executer 184C acquires, for example, the in-vehicle status information on the basis of the image captured by the in-vehicle camera 70. The executer 184C may acquire information indicating that the interface of the in-vehicle facility 72 is operated, as the in-vehicle status information, from the in-vehicle facility 72.

The executer 184C determines whether the restricting process is executed on the basis of the acquired in-vehicle status information (step S203). For example, in a case where information indicating an attempt to touch the object is acquired, or a case where information indicating that the object is being operated is acquired, the executer 184C executes the restricting process (step S205). Here, the executer 184C may execute the restricting process with respect to some of the objects (for example, an object attempted to be touched by a restricted person), or execute the restricting process with respect to all the objects.

Next, the warner 184D determines whether restriction based on the restricting process is executed by the occupant (step S207). In a case where it is determined that restriction based on the restricting process is executed by the occupant, the warner 184D executes the above-described predetermined process (step S209). The third controller 180 determines whether a restricted person alights from a vehicle (step S211). In a case where the restricted person does not alight from the vehicle, the third controller 180 returns to step 5201 and repeats the process. On the other hand, in a case where the restricted person alights from the vehicle, the third controller 180 terminates the process.

According to the first embodiment described above, it is possible to improve in-vehicle security by providing the determiner 183 that determines whether the occupant of the vehicle is a restricted person who is subject to restriction of use of the object within the vehicle in accordance with the mode of use of the vehicle, and the restricting processor 184 that executing the restricting process related to use of the object in a case where it is determined by the determiner 183 that the occupant is a restricted person.

### Second Embodiment

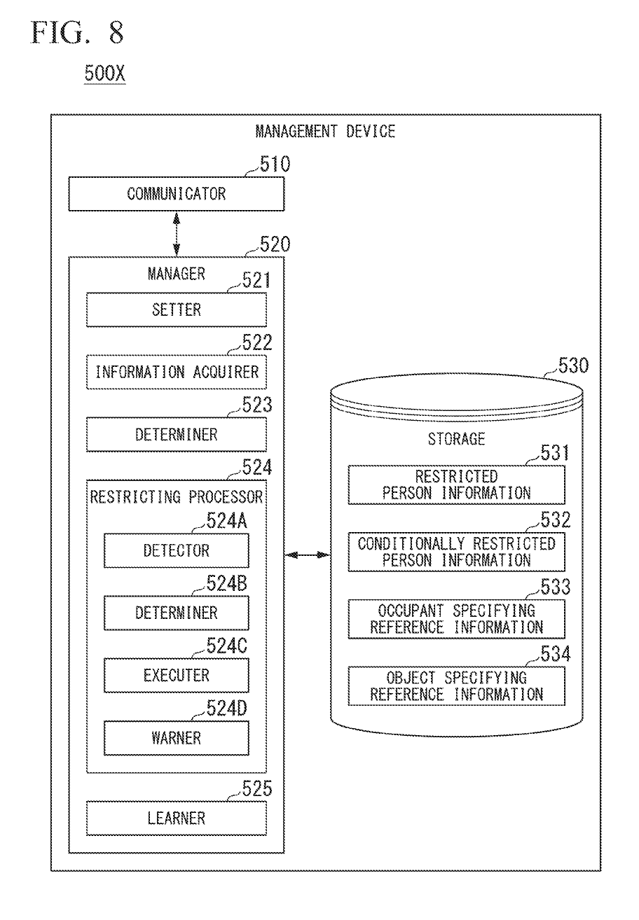

Next, a management device 500X according to a second embodiment will be described with reference to FIG. 8. The management device 500X according to the second embodiment includes a configuration equivalent to the third controller included in the vehicle control device 5 in the first embodiment.

FIG. 8 is a configuration diagram of the management device 500X according to the second embodiment. Components having the same functions as those in the first embodiment are denoted by the same names, and the detailed description thereof will not be given. As shown in FIG. 8, the management device 500X includes a communicator 510, a manager 520, and a storage 530. The communicator 510 includes, for example, a communication interface such as an NIC. The storage 530 is, for example, a RAM, a ROM, a flash memory such as an SSD, an HDD, or the like.

The storage 530 stores information such as, for example, restricted person information 531, conditionally restricted person information 532, occupant specifying reference information 533, or object specifying reference information 534.

The manager 520 includes, for example, a setter 521, an information acquirer 522, a determiner 523, a restricting processor 524, and a learner 525. The restricting processor 524 includes, for example, a detector 524A, a determiner 524B, and an executer 524C. The manager 520 executes the process as described above on the basis of information received from the vehicle control device 5 or information received from the terminal device 300 using the communicator 510.

According to the second embodiment described above, it is possible to exhibit the same effect as that of the first embodiment.

[Hardware Configuration]

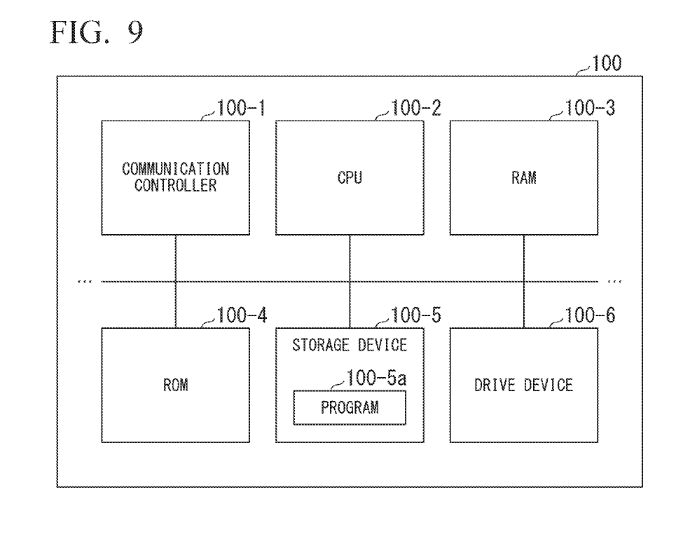

FIG. 9 is a diagram illustrating an example of a hardware configuration of the automatic driving control device 100 of an embodiment. As shown in the drawing, the automatic driving control device 100 is configured such that a communication controller 100-1, a CPU 100-2, a random access memory (RAM) 100-3 used as a working memory, a read only memory (ROM) 100-4 that stores a boot program or the like, a flash memory, a storage device 100-5 such as a hard disk drive (HDD), a drive device 100-6, and the like are connected to each other through an internal bus or a dedicated communication line.

The communication controller 100-1 performs communication with components other than the automatic driving control device 100. The storage device 100-5 stores a program 100-5a executed by the CPU 100-2. This program is developed into the RAM 100-3 by a direct memory access (DMA) controller (not shown) or the like, and is executed by the CPU 100-2. Thereby, some or all of the first controller 120, the second controller 160, and the third controller 180 are realized.

The above-described embodiment can be represented as follows.

A vehicle control device including:

a storage having a program stored therein; and

a hardware processor,

wherein the hardware processor executes the program stored in the storage, to thereby

acquires information indicating a mode of use of a vehicle on the basis of information acquired by a vehicle device mounted in the vehicle or information received from an external device,

determine whether an occupant of the vehicle is a restricted person who is subject to restriction of use of an object within the vehicle in accordance with the mode of use of the vehicle acquired; and

execute a restricting process related to use of the object in a case where the occupant is determined to be the restricted person.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

For example, the executer 184C may execute the restricting process at a timing when it is determined that the occupant is a restricted person without determining whether the restricting process is executed on the basis of the in-vehicle status information.

In a case where the personal possession detected by the detector 184A is a lost belonging of a customer of a shared car or a taxi, the restricting processor 184 may execute a process for causing the automatically driven vehicle to travel toward a predetermined destination (for example, a police box). The restricting processor 184 may transmit a message for notifying of the presence of a lost belonging to a terminal device of a user who lost his or her belonging, and execute a process for causing the automatically driven vehicle to travel toward a place designated by a user who lost his or her belonging.

In a case where the object is information stored in the storage, the restricting processor may restrict a process of reading out the information from the storage as a restricting process, or execute a process of deleting the information from the storage.

The management device 500 may acquire information indicating the mode of use of the automatically driven vehicle from the terminal device 300, and transmit the acquired information to the vehicle control device 5. The management device 500 may refer to the information stored in its own storage on the basis of the information received from terminal device 300, and determine the mode of use of the automatically driven vehicle.

What is claimed is:

1. A vehicle management system comprising:
an information acquirer that acquires information indicating a mode of use of a vehicle on the basis of information acquired by a vehicle device mounted in the vehicle or information received from an external device;
a determiner that determines whether an occupant of the vehicle is a restricted person who is subject to restriction of use of an object within the vehicle in accordance with the mode of use of the vehicle acquired by the information acquirer; and
a restricting processor that executes a restricting process related to use of the object in a case where the occupant is determined to be the restricted person by the determiner.

2. The vehicle management system according to claim 1,
wherein the restricting processor acquires status information indicating a status inside the vehicle on the basis of a detection result of a detector included in an in-vehicle facility or an image captured by an in-vehicle camera mounted within the vehicle, detects an article left within the vehicle as the object on the basis of the acquired status information, and executes the restricting process on the basis of a detection result.

3. The vehicle management system according to claim 2,
wherein the restricting processor executes the restricting process in a case where an action of the occupant relevant to the object is monitored on the basis of the status information and a predetermined action of the occupant is detected.

4. The vehicle management system according to claim 3,
wherein the predetermined action includes an action attempted to touch the object or a stored body stored in the object.

5. The vehicle management system according to claim 1,
wherein the information acquirer acquires information indicating a feature of the occupant on the basis of the information acquired by the vehicle device or the information received from the external device, and
the restricting processor decides the object on the basis of at least one of the feature of the occupant acquired by the information acquirer or the mode of use of the vehicle.

6. The vehicle management system according to claim 1,
wherein the restricting process includes any of a process of notifying that the use of the object is restricted and a process of physically or electrically restricting at least a portion of a function of the object.

7. The vehicle management system according to claim 1,
wherein in a case where restriction based on the restricting process is executed by the occupant, the restricting processor notifies an owner of the vehicle to that effect.

8. The vehicle management system according to claim 1,
wherein in a case where restriction based on the restricting process is executed by the occupant, the restricting processor restricts unlocking of a door of the vehicle.

9. The vehicle management system according to claim 1,
wherein in a case where restriction based on the restricting process is executed by the occupant, the restricting processor executes a process for causing the vehicle to travel toward a predetermined place.

10. The vehicle management system according to claim 2,
wherein the restricting processor detects the object using reference information, and
a learner that compares a status before the occupant's boarding of the vehicle with a status after the occupant's alighting from the vehicle on the basis of status information indicating a status inside the vehicle which is acquired by the information acquirer, and learns the reference information on the basis of a comparison result is further included.

11. The vehicle management system according to claim 5,
wherein in a case where the mode of use of the vehicle is not set, the determiner determines whether the occupant is the restricted person on the basis of the feature of the occupant.

12. The vehicle management system according to claim 5,
wherein the determiner determines whether the occupant is a conditional restricted person who is subject to partial restriction of use of the object on the basis of the feature of the occupant.

13. A vehicle management method comprising causing one or more computers to:
acquire information indicating a mode of use of a vehicle on the basis of information acquired by a vehicle device mounted in the vehicle or information received from an external device;
determine whether an occupant of the vehicle is a restricted person who is subject to restriction of use of an object within the vehicle in accordance with the mode of use of the vehicle acquired; and
execute a restricting process related to use of the object in a case where the occupant is determined to be the restricted person.

14. A computer readable non-transitory storage medium having a program stored therein, the program causing one or more computers to:
acquire information indicating a mode of use of a vehicle on the basis of information acquired by a vehicle device mounted in the vehicle or information received from an external device;
determine whether an occupant of the vehicle is a restricted person who is subject to restriction of use of an object within the vehicle in accordance with the mode of use of the vehicle acquired; and
execute a restricting process related to use of the object in a case where the occupant is determined to be the restricted person.
